(19) United States
(12) Patent Application Publication
(10) Pub. No.: US 2016/0373312 A1
(43) Pub. Date: Dec. 22, 2016

(54) PLATFORM APPLICATION VISUAL ANALYTICS SYSTEM

(71) Applicants: Magy Seif El-Nasr, Marlborough, MA (US); Allesandro Canossa, Brookline, MA (US); Truong-Huy Dinh Nguyen, Quincy, MA (US)

(72) Inventors: Magy Seif El-Nasr, Marlborough, MA (US); Allesandro Canossa, Brookline, MA (US); Truong-Huy Dinh Nguyen, Quincy, MA (US)

(21) Appl. No.: 15/185,405

(22) Filed: Jun. 17, 2016

Related U.S. Application Data
(60) Provisional application No. 62/180,773, filed on Jun. 17, 2015.

(51) Int. Cl. H04L 12/24; A63F 13/20; G06F 3/0484; G06F 3/0482; H04L 29/08; G06F 3/0481

(52) U.S. Cl. CPC H04L 41/22; H04L 67/10; G06F 3/04817; G06F 3/04847; G06F 3/0482; A63F 13/20

(57) ABSTRACT

Disclosed herein are apparatus, devices, and methods to provide visual analytics of GUI objects generated based on a transformation of metrics information resulting from user interaction with a platform application. The GUI objects may include map GUI objects operative to visualize metrics information within a virtual map of an application environment. The map GUI objects may be modified based on visualization requests, including, without limitation, a location and/or a time of interest or compound requests, such as a plurality of events according to a relationship. The GUI objects may include state network GUI objects to graphically depict platform application states and sequence network GUI objects to graphically depict platform application sequences as nodes within a graph. The state network GUI objects and the sequence network GUI objects may be presented according to synchronized visualization to allow for the simultaneous interaction and visualization of metrics information at different levels of granularity.

### CROSS-REFERENCE TO RELATED APPLICATION

This application claim the benefit of priority of 35 U.S.C. §119(e) to U.S. Provisional Patent Application Ser. No. 62/180,773, filed on Jun. 17, 2015, which is incorporated by reference in its entirety as if fully set forth herein.

### BACKGROUND

Software developers are able to collect information relating to user interactions with their products. Product analytics generally involves an analysis of these user interactions to gain insight into product functionality and how users operate product components. Such analysis allows developers to better understand their users and, ultimately, to improve the user experience. For example, game user research allows game developers and other stakeholders to observe and analyze player behavior compared against anticipated player responses to game components and playing conditions.

Understanding player behavior and obtaining meaningful insight from user actions performed in a game is a time-consuming, resource-intensive process that requires thorough domain knowledge of the design of the game and advanced technical skills, such as advanced experience with database query languages and statistical packages. Game designers may possess the domain knowledge, but generally lack the required technical skills. Technical experts may have the knowledge necessary to perform meaningful queries; however, they often do not have the intimate knowledge of game components and levels to connect the query results with the actual game design. Accordingly, although researchers are able to obtain vast amounts of gameplay data, conventional technology does not provide for efficient and effective analysis of this data to achieve meaningful insight into player behaviors.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

In an embodiment, an apparatus may include a processor circuit and a memory unit coupled to the processor circuit. The memory unit may store a visual analytics application operative on the processor circuit to graphically present metrics information of a platform application. The visual analytics application may include a metrics component to receive metrics information generated by interaction with the platform application and a GUI interface component. The GUI interface component may be operative to generate a visual analytics interface for presentation of at least one map graphical user interface (GUI) object to graphically represent at least a portion of the metrics information within an application environment, receive a visualization request via at least one interactive selection GUI object, and present the at least one map GUI object updated based on the visualization request.

In an embodiment, an apparatus may include a processor circuit and a memory unit coupled to the processor circuit, The memory unit may store a visual analytics application operative on the processor circuit to graphically present metrics information of a platform application. The virtual platform metrics application may include a metrics component to receive metrics information generated by interaction with the platform application and a GUI interface component. The GUI interface component may be operative to generate a visual analytics interface for a synchronized presentation of a state map graphical user interface (GUI) object adjacent to a sequence map GUI object, the state map GUI object to graphically represent platform application states as nodes based on the metrics information, the sequence map GUI object to graphically represent platform application sequences as nodes based on the metrics information, receive a visualization request via the visual analytics interface, and present the state map GUI object and the sequence map GUI object updated based the visualization request.

In an embodiment, a computer-implemented method to graphically present metrics information may include, by a processor circuit, receiving metrics information generated by interaction with the platform application, generating a visual analytics interface for presentation of at least one map graphical user interface (GUI) object to graphically represent at least a portion of the metrics information within an application environment, receiving a visualization request via at least one at least one interactive selection GUI object, and presenting the at least one map GUI object updated based the visualization request.

### BRIEF DESCRIPTION OF THE DRAWINGS

FIG. 1 depicts a block diagram of an illustrative visual analytics system according to some embodiments.

FIG. 2 illustrates an embodiment of an operating environment for a visual analytics system according to some embodiments.

FIGS. 3A-3F illustrates an embodiment of an operating environment for the visual analytics system according to some embodiments.

FIGS. 4A-4D illustrates an embodiment of an operating environment for the visual analytics system according to some embodiments.

FIG. 5 depicts an illustrative logic flow according to a first embodiment.

FIG. 6 depicts an illustrative logic flow according to a second embodiment.

FIG. 7 illustrates an exemplary embodiment of a computing architecture.

### DETAILED DESCRIPTION

The described technology generally relates to visual analytics systems for analyzing user interactions with a platform. In some embodiments, a visual analytics system may receive metrics information relating to user (e.g., “platform user”) interactions with the platform. The visual analytics system may generate and/or access various graphical user interface (GUI) objects based on the metrics information. One or more interactive visual analytics GUI objects graphically representing metrics information may be presented via a computing device to an analyst (e.g., “analyst user”) responsive to a request. The visual analytics GUI objects may operate to facilitate the efficient and effective visual analysis of metrics information, platform user actions, and/or platform user behavior.

A platform may generally include a software application, including, without limitation, a video game application, a mobile application (e.g., “mobile app” or “app”), a web site, an e-commerce web site, a productivity application, an electronic program guide, a database application, sensor information from real-world events (e.g., a sporting event), and/or the like. The metrics information may generally include information relating to user interaction with the platform including, without limitation, login/logout information, input information (e.g., input device selections, keyboard entries, and/or the like), object interactions, traveled pathways, purchases, dialog, interaction duration, completion of objectives, and/or the like. For instance, for a game application, metrics information may include, but is not limited to, a unique user identifier, computing device information (e.g., computing device type, unique identifiers, resource information, and/or the like), dialog, interactions with non-player characters (NPCs), kills, fights, deaths, resources (e.g., strength, lives, ammunition, currency, armor, weapons, assets, and/or the like), experience levels and/or points, number of rounds played per time period (e.g., session, day, week, and/or the like), choices, levels, movement information, alliances, strategies, and/or the like. In another instance, in an e-commerce application, metrics information may include, without limitation, browsing information, products, ratings, purchases, returns, navigation information, platform user feedback, and/or the like. In some embodiments, at least a portion of the metrics information may be categorized as an event within the platform, for instance, that consists of a specific, defined activity. For example, the metrics information for a real-time strategy (RTS) game may include completion of a level. In some embodiments, the metrics information may be associated with an object, such as a user (e.g., a game player profile or login identifier), an asset (e.g., a weapon in a first-person shooter (FPS) game application), a location within the platform (e.g., a building in a role playing game (RPG) game application or a purchasing interface of an e-commerce web site), an NPC, an event, and/or the like.

In some embodiments, the visual analytics GUI objects generated and/or accessed by the visual analytics system may include a map GUI object. In general, a map GUI object may include a map of at least a portion of the visual environment of the platform application annotated, overlaid, or otherwise modified with graphical objects generated based on the metrics information. In a non-limiting example, a map GUI object may include a heat map graphically presenting the movement of players within a level of a game application. In another non-limiting example, a map GUI object may include a heat map graphically representing the movement of an input device cursor (e.g., a mouse cursor) over a web page of an e-commerce web site presenting a product. In some embodiments, the visual analytics system may operate to present customized map GUI objects generated based on one or more attributes. For example, a GUI object may include a heat map specific to a particular location, one or more platform users (e.g., a novice platform user, an experienced platform user, specific platform user identifiers, specific platform user strategies, and/or the like), and event, an activity, and/or a time period (e.g., first ten minutes of gameplay).

In some embodiments, the visual analytics GUI objects may include network (or graph) GUI objects. In general, a network GUI object may include a graph configured to represent states and/or sequences of platform user activity within a platform. In a non-limiting example, a network GUI object for a game application may include a state network GUI object configured to represent game states (e.g., instances of platform user decisions and/or actions) as nodes and to represent decisions and/or actions taken by a platform user to move between states as links between the nodes. In another non-limiting example, a network GUI object for a game application may include a sequence network GUI object configured to visually represent various sequence patterns performed by platform users. For example, a sequence network GUI object may include a node for each completed and/or possible gameplay sequence within the game platform. Various characteristics of each node may provide information about the sequence and/or a relationship between sequences. For instance, a size, color, or other visible feature of a node may indicate a popularity of the associated sequence. In another instance, a distance between nodes may indicate the difference between the sequences corresponding to the nodes (e.g., the greater the distance between two nodes, the greater the difference between the sequences represented by the nodes, and vice versa).

In some embodiments, the visual analytics system may operate to present a plurality of visual analytics GUI objects in order to allow an analyst user to efficiently and effectively obtain insights into user behavior and/or platform function using the visualized metrics information. For instance, a state network GUI object may be presented adjacent to a sequence network GUI object. In this manner, an analyst user may select a sequence on the state network GUI object and be able to instantaneously visualize the corresponding state information corresponding to the selected sequence via the sequence network GUI object, and vice versa. Accordingly, an analyst user may simultaneously interact with metrics information at two different levels of granularity.

The visual analytics system provides multiple technological advances over and provides multiple technical features not present in traditional paper-based systems, conventional computer-based systems, and/or hybrid paper- and computer-based systems. Paper-based systems, such as conventional charting and/or mapping techniques, are not capable of providing a user interface for interactive access to metrics information, action or event sequences, pathways between actions or events, and/or the like. In particular, traditional paper-based information systems rely on collections of paper charts and past records of platform use. Such paper files are not capable of being automatically or dynamically updated and do not provide access to a platform's complete history, including multiple iterations of a platform. Accordingly, platform developers and other stakeholders are not able to access all of the information necessary to efficiently make accurate and reliable assessments using such paper-based files. In addition, platform research and development professionals are not able to efficiently access the information that they need, as obtaining information requires physically searching through multiple documents, charts, and other files. Conventional computer-based systems suffer from much of the same deficiencies as paper-based systems, except that the platform developer is interacting with a computer screen instead of a paper file.

Although a computer is able to locate and process information much faster, such conventional computer-based systems are not configured to present the metrics information in an efficient, meaningful way that assists platform developers with making faster and more accurate decisions for improving platform functionality and/or user experience. Conventional computer-based systems require platform developers to go through myriad tedious drop-down selections, pages, search queries, documents, charts, and static information graphics in order to access information. Conventional computer-based systems are able to present information faster, however, they are not able to present meaningful information that assists platform developers with efficiently sharing information and making quick and accurate decisions.

The GUI interfaces for graphically representing metrics information according to some embodiments function differently from conventional GUI interfaces. For example, the GUI interfaces according to some embodiments improve the way that a computer graphically presents information to users and allows users to interact with the information. The methods and systems described according to some embodiments, in contrast with conventional technology, reduce the time and cognitive effort required for platform developers and other stakeholders to access, quantify, and assess metrics information. For example, a game designer is better able to make efficient and accurate decisions about improving the user experience of a platform user of an RPG application using the methods and systems described according to some embodiments in comparison to conventional information techniques. In addition, the methods and systems described according to some embodiments assist platform developers with effectively and dynamically sharing information, for example, between departments, developers, or the like in a meaningful way that leads to faster and better decision making. For example, methods and systems described according to some embodiments would allow a platform developer working to improve the user experience of a game application to quickly and intuitively access metrics information with one GUI selection depicting the relationship between a plurality of events within the game environment and/or to simultaneously visualize sequence information at multiple levels of granularity without having to search through multiple documents or pages and/or to ask a colleague for the information, as would be required using a conventional information system. in this manner, the system may streamline non-verbal communication by effectively displaying metrics information, customized platform maps, sequences, sequence relationships, and/or the like.

A system according to the described embodiments may be configured to transform metrics information into a format that is easily accessible to platform research and development professionals. For instance, the system may be configured to transform metrics information into objects, object values, and/or characteristics of objects displayed on a graphical user interface. in some embodiments, the system may be configured to transform metrics information into color, size, and/or distance schemes configured to indicate platform activity, player movements, sequences, sequence relationships, or the like. In this manner, information may be transformed into graphical interface objects and/or characteristics thereof that may be used to allow platform development professionals to more efficiently, effectively, and accurately assess and improve platform functionality and/or user experience, than is possible using conventional techniques and processes.

The system presents novel software tools and user interfaces that solve technical problems relating to providing platform research and development services. A non-limiting example of a technical problem that is solved by the system is providing efficient and effective access to the information necessary to determine user interactions with a platform and/or components thereof. Using conventional technology, such information is located in disparate locations, including paper charts or separate databases. Thus, using such conventional technology, it may not be feasible or possible to obtain and/or understand the necessary information. For example, a software developer using conventional technology may have to develop specific queries and consult multiple information graphics presented individually to obtain information concerning how users interact with a particular object during a specific event.

Embodiments of the described technology provide specific improvements to computer-related technology and conventional technological processes by solving these technical problems, as well as multiple others. A system according to various embodiments of the present teachings can solve these technical problems, as well as multiple others, for example, by centralizing the information relating to platform user interactions and presenting this information to platform research and development professionals in a user friendly and efficient manner. The system also solves the technical problem of allowing a user to efficiently navigate in an intuitive way through the information available within the system. In addition, the system solves the technical problem of allowing a user to intuitively and efficiently customize information graphics. Furthermore, the system solves the technical problem of allowing a user to intuitively and efficiently obtain simultaneous access to multiple forms of information, including at different levels of granularity. In this manner, platform research and development professionals are able to more completely, accurately, and efficiently access information required to analyze metrics information, develop platform functionality, and improve user experience.

The systems and methods present multiple novel functions and features involving the analysis of platform metrics information. For example, embodiments allow for the efficient and visual-based forming of hypotheses and verification of multi-modal data. Embodiments also allow for insights into spatial and non-spatial behavior data simultaneously within a single interface. Embodiments may also provide for the building of complex visualization queries using simple operations (e.g., Boolean operations, set operations, and/or the like) and spatial and/or temporal constraints. Accordingly, the described technology allows for the improved and faster turnaround of data analysis and conclusion formation of platform metrics information. Embodiments also allow for less skilled and/or experienced users to obtain advanced insight into platform user behavior and to perform complex queries and analysis due to the visualization of information and by allowing easy, efficient manipulation of visualized information. In addition, synchronized visualization of metrics information at different granularity levels allows for easy recognition and comparison of platform user behavior patterns. As such, the systems according to the described embodiments provide a technological advantage over current techniques and technology.

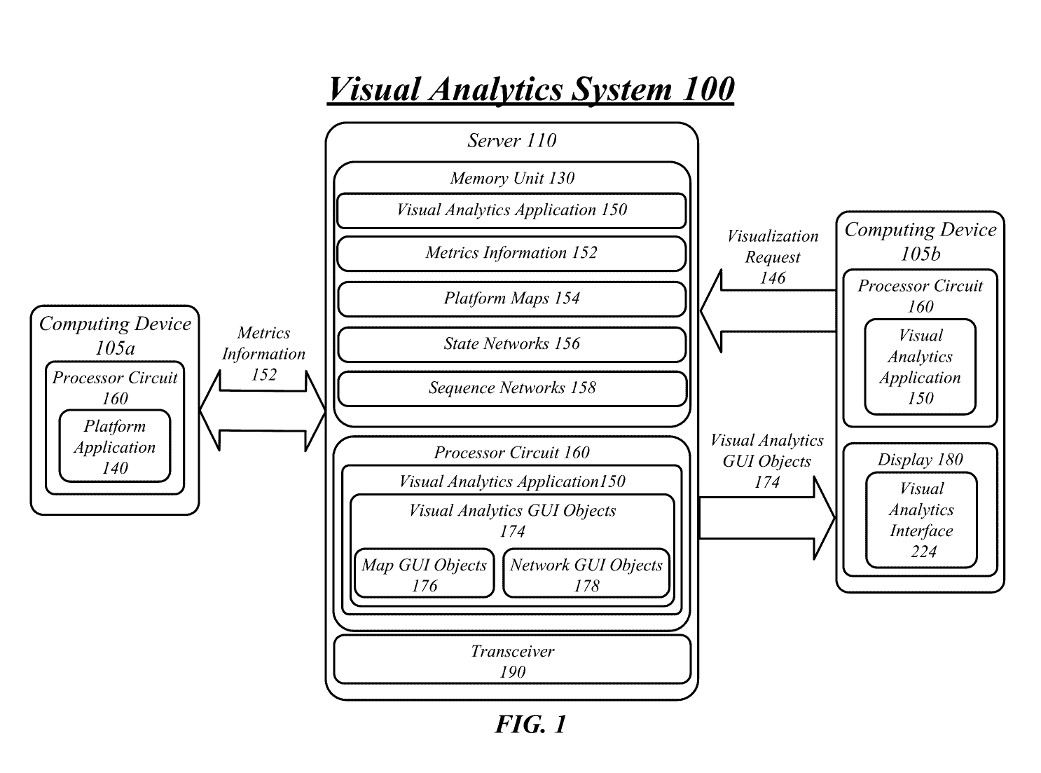

FIG. 1 depicts a block diagram of an illustrative visual analytics system 100 according to some embodiments. In some embodiments, a visual analytics system 100 may include a computer-based system having a server 110, computing device 105a, and/or computing device 105b. Although the visual analytics system 100 shown in FIG. 1 has a limited number of elements in a certain topology, it may be appreciated that the visual analytics system 100 may include more or less elements in alternate topologies as desired for a given implementation

The server 110, computing device 105a, and/or computing device 105b may include various electronic devices. Some examples of an electronic device may include, without limitation, an ultra-mobile device, a mobile device, a personal digital assistant (PDA), a mobile computing device, a smart phone, a telephone, a digital telephone, a cellular telephone, electronic readers (e.g., eBook readers, e-readers, etc.), a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

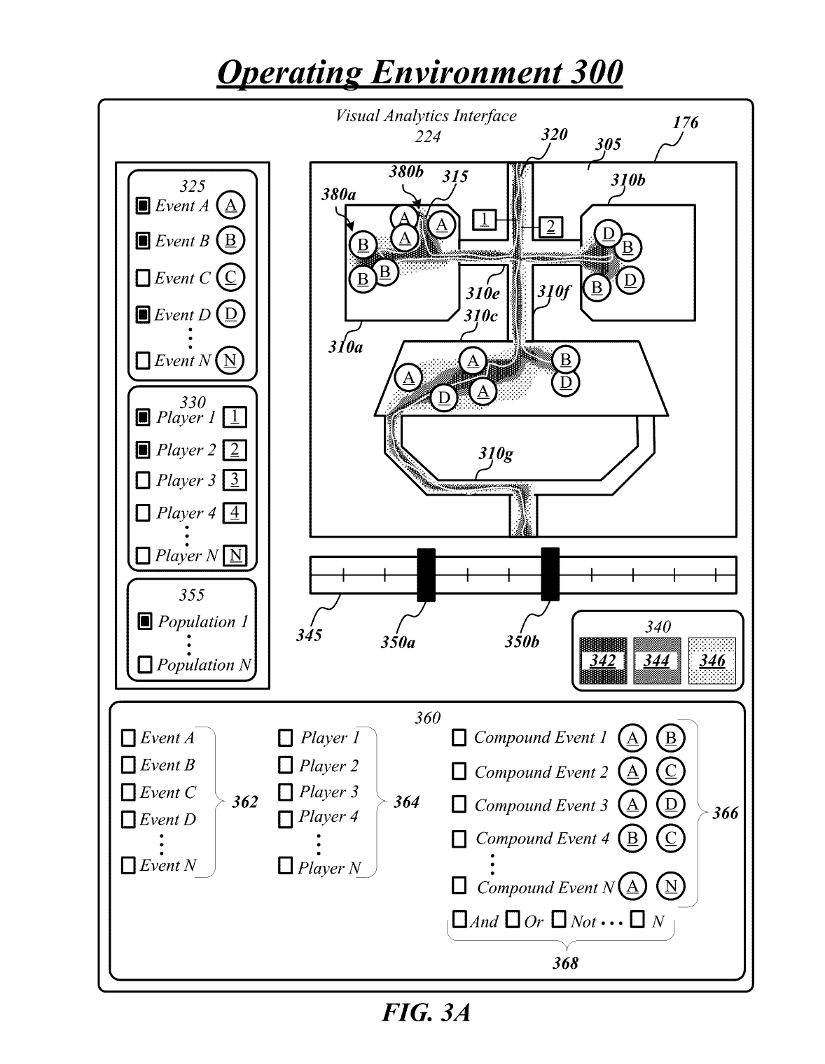

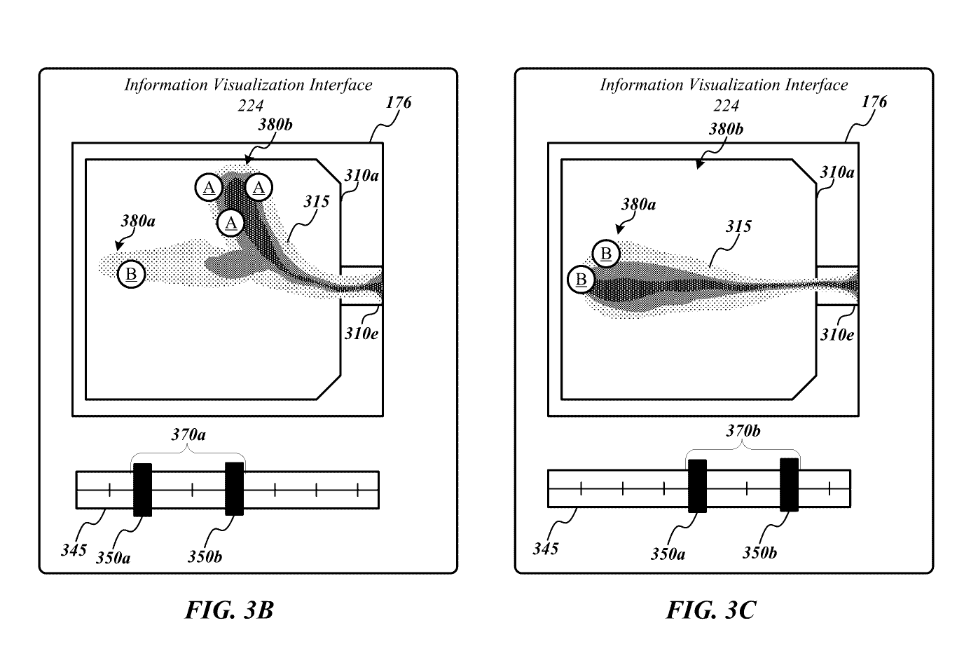

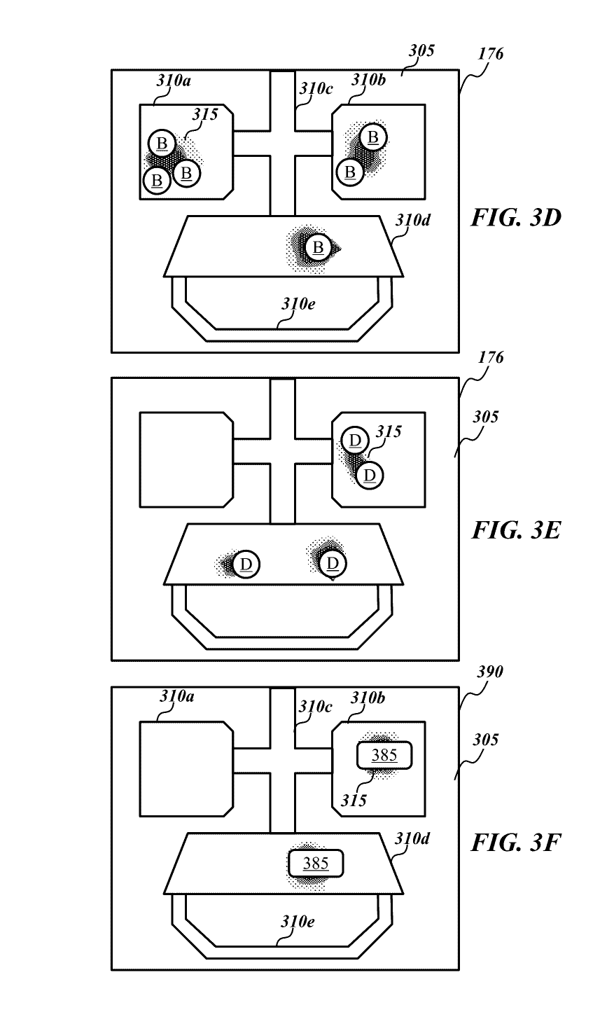

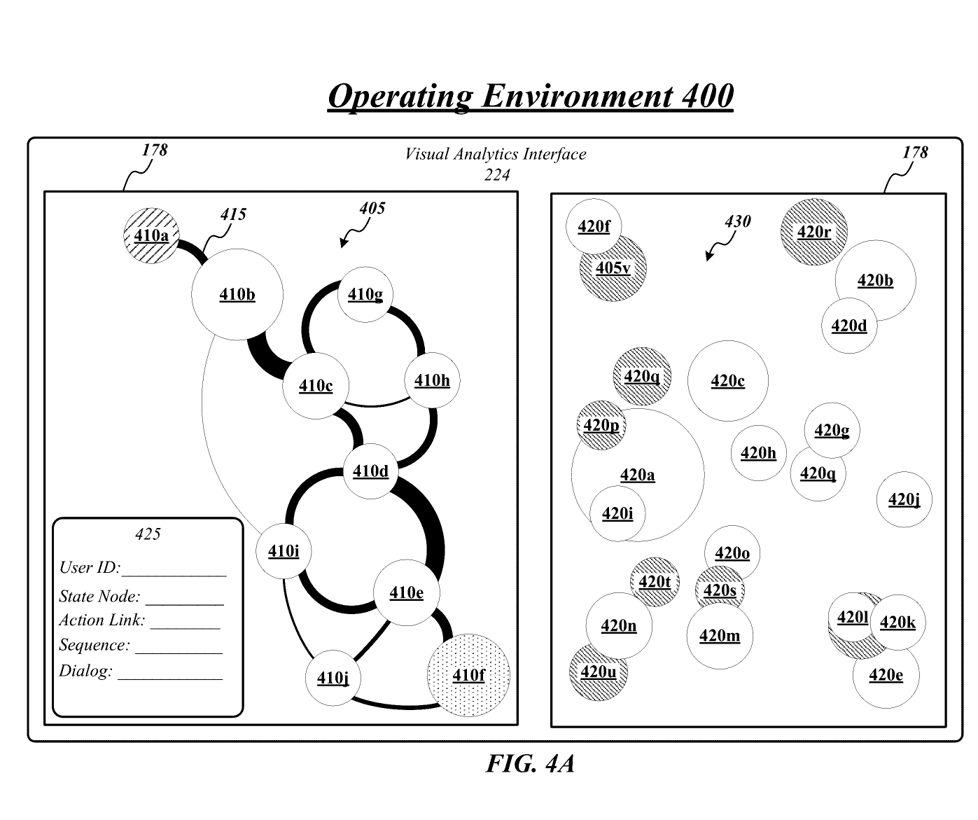

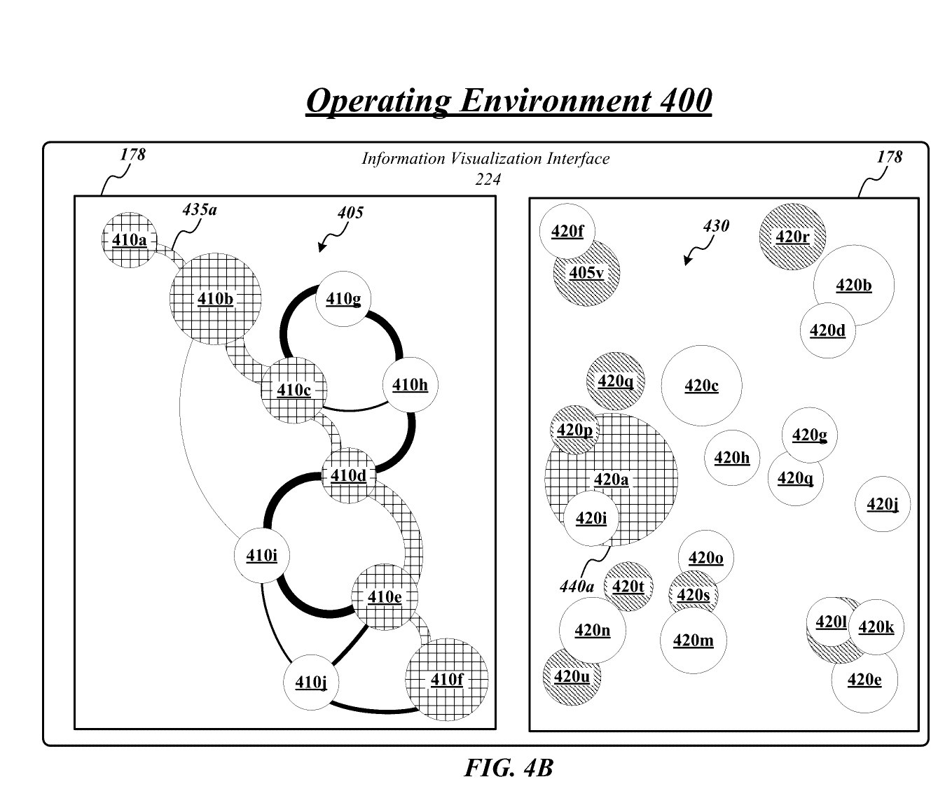

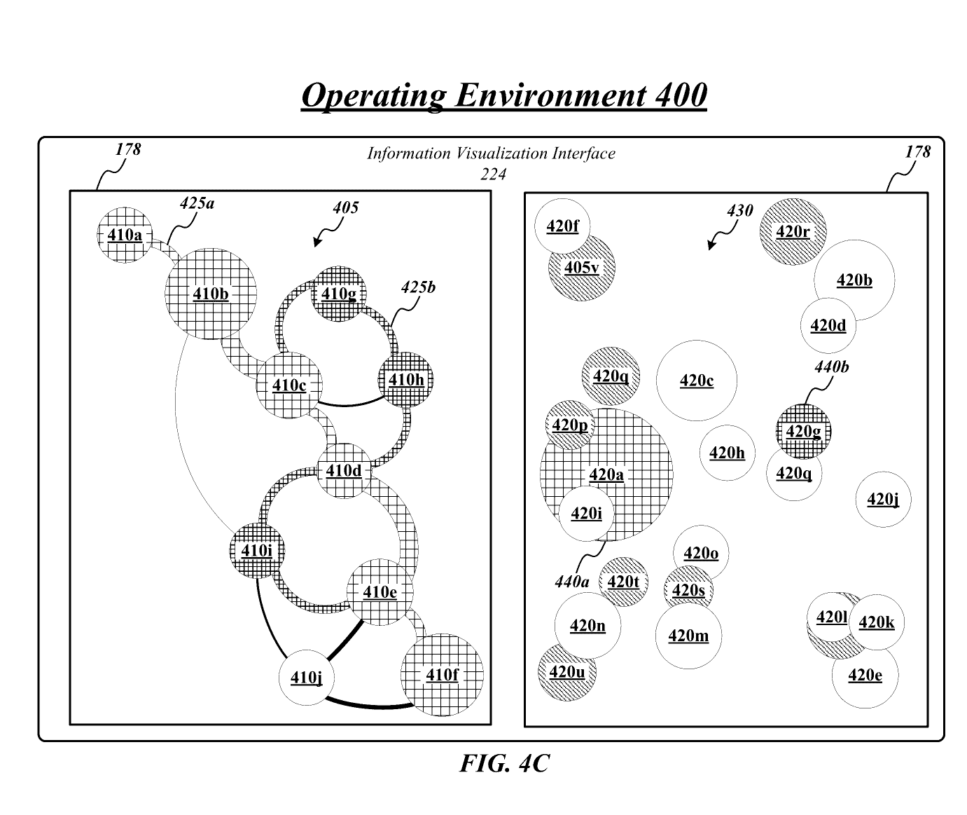

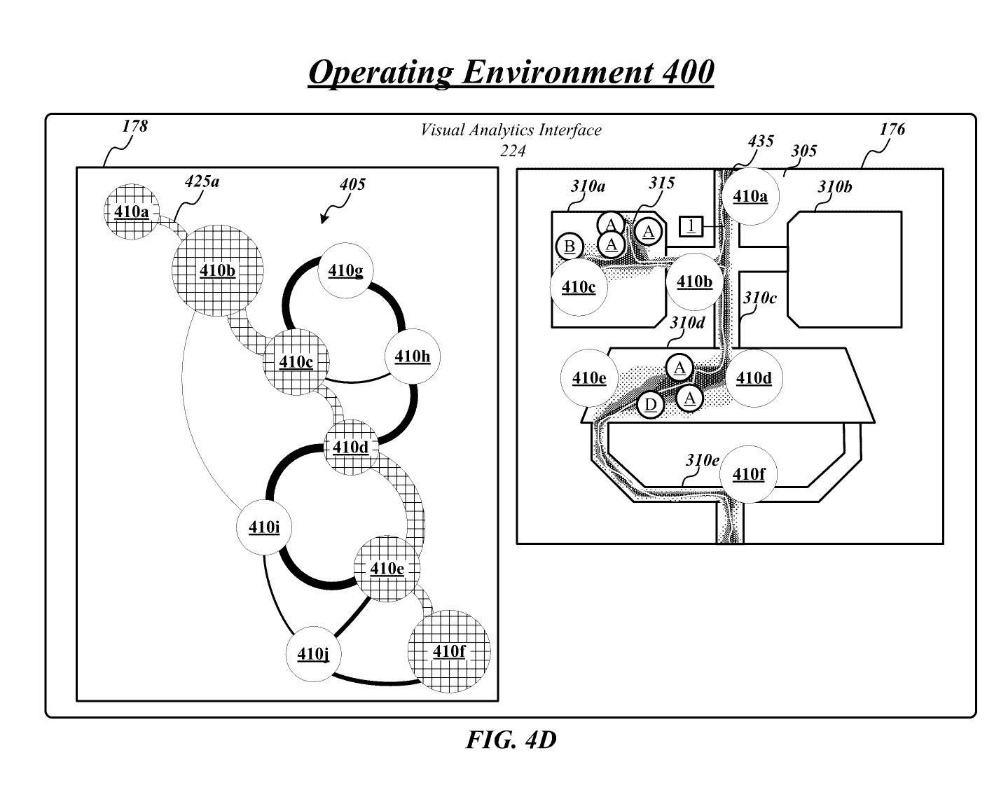

The server 110 may include, for example, a memory unit 130, a processor circuit 160, and one or more transceivers 190. The server 110 may further have installed a visual analytics application 150. The memory unit 130 may store an unexecuted version of the visual analytics application 150 and metrics information 152. In some embodiments, the memory unit 130 may store, among other types of information, platform maps 154, state networks 156, and/or sequence networks 158 generated by the visual analytics application 150 and/or obtained from various third party sources. The visual analytics application 150 may generally operate on the server 110 to generate visual analytics GUI objects 174. Non-limiting examples of visual analytics GUI objects 174 may include, without limitation, map GUI objects 176 (see, for example, FIGS. 3A-3F) and network GUI objects 178 (see, for example, FIGS. 4A-4D).

The computing device 105a may include a processor circuit 160 for executing a platform application 140. For instance, computing device 105a may include a mobile computing device, personal computer, or game system configured to execute a game application. Interaction with the game application 140 via the computing device 105a may generate metrics information 152 that is transmitted to or otherwise accessed by the server 110. The computing device 105b may include a processor circuit 160 configured to execute a visual analytics application 150. In some embodiments, the visual analytics application 150 being executed on the computing device 105b may be a client application, web-based interface, or the like for accessing the visual analytics application 150 and/or information stored on the server 110. An analyst user may transmit a visualization request 146 to the server, for example, to view a virtual analytics GUI object 174 and/or to otherwise access metrics information 152. The server 110 may be configured to transmit virtual analytics GUI objects 174 for display to the analyst user via a display 180 of the computing device 105b. In some embodiments, the platform application 140 may be executed on the processor circuit 160 of the server 110. In some embodiments, a platform user may interact with the platform application 140 via the server 110. In some embodiments, an analyst user may access metrics information 152 and/or view virtual analytics GUI objects 174 via the server 110.

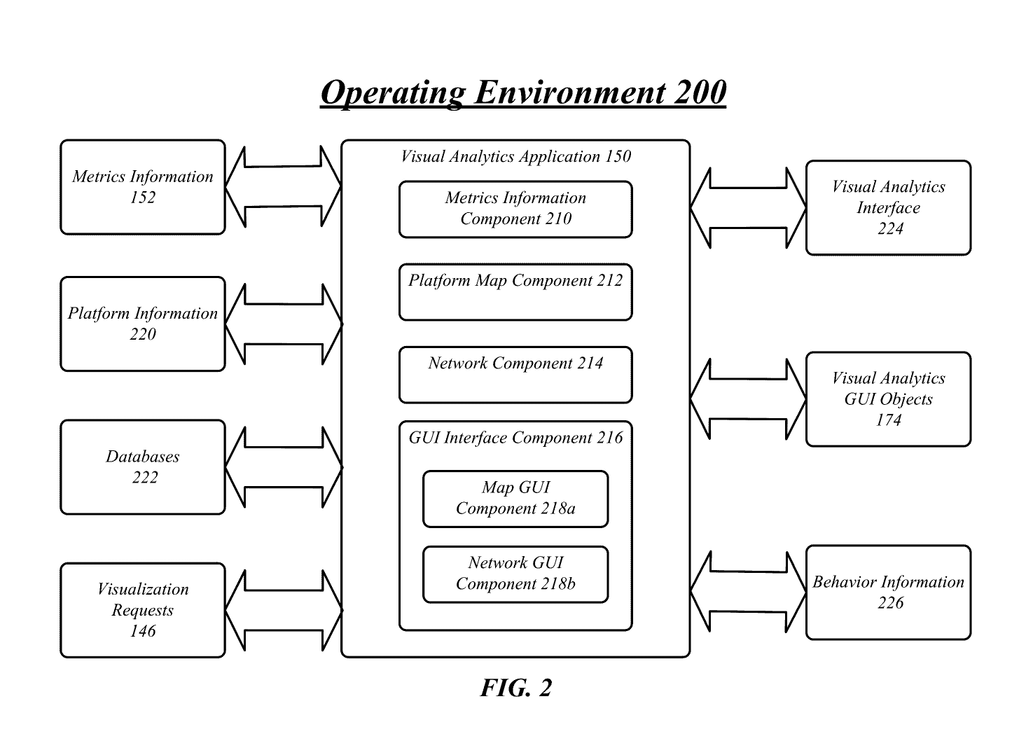

FIG. 2 illustrates an embodiment of an operating environment 200 for the visual analytics system 100. More particularly, the operating environment 200 may illustrate a more detailed block diagram for the visual analytics application 150.

As shown in FIG. 2, the visual analytics application 150 may comprise various components 210, 212, 214, 216, 218a, 218b. As used in this application, the term “component” is intended to refer to a computer-related entity, either hardware, a combination of hardware and software, software, or software in execution. For example, a component can be, but is not limited to being, a process running on a processor, a processor circuit, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections, Exemplary connections include parallel interfaces, serial interfaces, and bus interfaces.

In the illustrated embodiment shown in FIG. 2, the visual analytics application 150 may comprise a metrics information component 210, a platform map component 212, a platform network component 214, and a GUI interface component 216 that includes a map GUI component (or sub-component) 218a and a network GUI component 218b (or sub-component). Although the visual analytics application 150 shown in FIG. 2 has only six components in a certain topology, it may be appreciated that the visual analytics application 150 may include more or less components in alternate topologies as desired for a given implementation. The embodiments are not limited in this context.

The metrics information component 210 may generally receive, generate, manage, or otherwise process metrics information 152 for one or more platform applications 140. In general, the metrics information 152 may include any information associated with user interaction with a platform application 140. Non-limiting examples of metrics information 152 may include user identifiers, computing device identifiers, user categories, user social network information, platform navigation information, object selections, input device input, and/or the like. For a game platform application 140, metrics information may include, but is not limited to, user identifiers, NPC interactions, location information, movement information, events and/or actions (e.g., interaction with an NPC, dialog, dialog responses, kills, fights, purchases, currency events, level completion, quitting game application, and/or the like), and/or the like. In some embodiments, the metrics information 152 to be collected and/or generated may be specified by an analyst user of the visual analytics application 150. For example, an analyst user may specify that metrics information 152 be collected relating to one or more specific events and/or types of users (e.g., novice users having a playing time below a threshold amount, experienced users having a playing time above a threshold amount, users that employ a particular game strategy, platform user personality profile, and/or the like).

The metrics information 152 may be generated, accessed, and/or collected via various processes. In some embodiments, the metrics information 152 to be collected and/or generated may be specified by code, instructions, or the like within the visual analytics application 150. Non-limiting examples of processes for generating, accessing, and/or collecting metrics information 152 may include use of specific code embedded in the platform application that captures platform user activity, telemetry, lab studies of platform application testers, remote tracking of platform application logs, focus groups, think-aloud protocols, retrospective interviews, use of third-party databases, and/or the like.

The metrics information 152 may be generated, collected, and/or provided in various forms. In some embodiments, the metrics information 152 may include data records, for instance, stored in one or more databases. In one non-limiting example, the metrics information 152 for an RPG game application may include a comma-separated values (CSV) format, including, without limitation, location information, object interaction, dialog choices, and NPC interactions (e.g., talking, fighting, and/or the like). In another non-limiting example, the metrics information 152 for a FPS game application may include a user identification value, a time stamp, a data type (e.g., a location record, a dialog record, an event record, an activity record, and/or the like), vector information for location, dialog information (e.g., interacting NPC and/or other platform user, dialog text, response text, response decision, and/or the like). The embodiments are not limited in this context.

In some embodiments, the metrics information component 210 may be configured to generate metrics information 152 in the form of metrics objects based on the metrics information 152. For instance, the metrics information component 210 may generate metrics objects based on analyst user and/or developer instructions. Non-limiting examples of metrics objects may include states (e.g., an analyst user may define a set of conditions as a user-defined state, or the like), sequences, strategy objects (e.g., a group of players that exhibit a defined strategy), platform user objects (e.g., novice groups, experienced groups, personality profiles), and/or the like.

In some embodiments, the metrics information component 210 may be configured to obtain metrics information 152 from third-party databases 222. For example, a game developer may provide access to a metrics information database 222 for a game application. The metrics information component 210 may be configured to access metrics information 152 stored in the metrics information databases 222 for use within the visual analytics application 150.

in some embodiments, the metrics information component 210 may be configured to format the metrics information 152, for example, into one or more common data formats. In this manner, the visual analytics application 150 may use metrics information 152 for various platform applications 140. For example, a first game application may generate metrics information 152 in a first format and a second game application may generate metrics information 152 in a second format. The metrics information component 210 may be configured to process the metrics information 152 from the first game application and the second game application into a common format (or convert into a particular format) so that the data may be compared, visualized, or otherwise used within the visual analytics application 150. Accordingly, multiple different platform applications 140 may be used to generate visual analytics GUI objects 174 according to some embodiments described herein.

The platform map component 212 may generally receive, generate, manage, or otherwise process GUI objects in the form of platform maps 154 for one or more platform applications 140, In general, a platform map 154 may include a GUI object in the form of a visual representation of the visible environment of a platform application 140 modified to include GUI objects generated based on the metrics information 152. In some embodiments, the platform map component 212 may receive platform information 220 associated with the platform application environment. In general, the application environment includes the visible environment and objects that a platform user may encounter and/or interact with when using the platform application 140. For example, for a mobile app, the application environment may include the application windows, buttons, text boxes, navigation information (e.g., how to navigate between application windows, events triggered by buttons, and/or the like), and/or the like. In another example, for a game application, the application environment may include landscape information, terrain information, NPC locations, buildings, vehicles, asset (e.g., weapons, money, armor, and/or the like) locations, and/or the like. In some embodiments, the platform information 220 may include graphics files used to present the application environment (*.xtml, *.bmp, *.jpeg, *.img, *.png, *.dae, *.ma, *.mb, and/or the like). In some embodiments, the platform map component 212 may use the graphics files for generating the platform maps.

In some embodiments, a platform map 154 may include a heat map GUI object configured to provide a graphical representation of the metrics information 152, for instance, superimposed over the application environment of the platform application 140 (see, for example, FIG. 3A). For instance, in a game application, a platform map 154 may be generated in the form of a heat map configured to graphically depict aggregated metrics information 152 to illustrate frequency of movement within the environment of the game application. In some embodiments, a platform map 154 may include an event map configured to depict a location and/or frequency of events (e.g., dialog, fights, kills, and/or the like) superimposed over the application environment. For example, the platform map component 212 may generate GUI objects in the form of events graphically depicted as icons superimposed over a location in the game application environment where the events occurred (see, for example, FIG. 3A).

In some embodiments, the platform map component 212 may be configured to generate the platform maps 154 using the metrics information 152 and/or the platform information 220. The platform information 220 may include graphics files for the application environment and/or coordinate information of locations, objects, or the like within the application environment. The platform map component 210 may map events, movements, and/or the like onto the application environment using, for instance, location information in the metrics information 152, For example, the metrics information 152 may include data records having a user identifier field that specifies a user identifier, a dialog field that specifies a particular dialog event, and a location field that provides coordinates of the location of the dialog event. The platform map component 212 may generate a platform map 154 GUI object by graphically representing the dialog events at locations within the application environment using the information specified in the location field and coordinate information specified in the platform information 220.

In some embodiments, the platform map component 212 may be configured to obtain platform maps 154 from one or more third-party databases 222. In some embodiments, the platform map component 212 may be configured to augment platform maps 154 Obtained from a third-party database 222 with metrics information 152. For example, a third-party platform map 154 may include a first set of movement information for a region of a game application environment. The platform map component 212 may be configured to superimpose events and/or a second set of movement information (and/or merge the first set of movement information and the second set of movement information) onto the first set of movement information based on the metrics information 152.

The network component 214 may generally receive, generate, manage, or otherwise process GUI objects in the form of state networks 156 and/or sequence networks 158 for one or more platform applications 140. In general, a state network 156 may include a GUI object in the form of a visual representation of application states and actions (see, for example, FIG. 4A). For example, a state network 156 may include nodes configures to represent different application states and links between nodes configured to represent platform user actions to proceed from one state to another. In some embodiments, the state network 156 may include a directed graph and/or directed links (i.e., each link has a particular directionality). For example, in a mobile app, a first state may be a first GUI interface (e.g., a login page) having a plurality of buttons, a second state may be a. button selection (e.g., open new file button), and a third state may be a second GUI interface (e.g., an open new file dialog) presented to a user responsive to selection of the button. In another example, in a game application, a first state may be a first dialog event initiated by an NPC (e.g., an NPC requesting that a platform user perform a task), a second state may be a second dialog event initiated by a platform user in response to the first dialog event (e.g., the platform player accepting the task), and a third state may be a third dialog event initiated by the NPC in response to the second dialog event (e.g., the NPC providing information to the platform user for starting the task).

In general, a sequence network 158 may include a GUI object in the form of a visual representation of sequences of states and/or actions performed by platform users with the platform application (see, for example, FIG. 4A). For example, in a sequence network 158, each sequence between platform application states may be represented as an individual node in the sequence network 158. Each node in the sequence network 158 may include one or more node characteristics to graphically represent one or more properties of the sequence represented by the node. Non-limiting examples of node characteristics may include, without limitation, size, color, location, opacity, distance from other nodes, shape, and/or the like. For example, a size of a node may represent a popularity of a sequence (e.g., higher-popularity sequences may be larger than lower-popularity sequences, and vice versa). In another example, a color of a node may represent a type of sequence (e.g., a completed sequence, a non-completed sequence, level completion, product purchase, and/or the like). In a further example, a distance between nodes may represent how different each sequence represented by the nodes is from other sequences (e.g., a greater distance between nodes may indicate a greater difference between sequences represented by the nodes). In a still further example, the shape of a node may represent a category of user associated with the sequence (e.g., circular nodes may represent sequences completed by novice users, square nodes may represent sequences completed by experienced users, and/or the like) In some embodiments, one or more nodes in a sequence network 158 may be associated with one or more labels configured to provide information about the node and/or the sequence represented by the node (e.g., nodes of completed sequences may be labeled as “completed”).

During operation, the GUI interface component 216 may generate GUI objects for representing metrics information 152, platform maps 154, state networks 156, sequence networks 158, application interfaces, and/or combinations thereof in a manner that provides for the efficient and effective analysis of platform application 140 functionality and/or platform user interaction with a platform application 140 (see, for example, FIGS. 3A-3F and FIGS. 4A-4C). During operation, the GUI interface component 216 may generate a visual analytics interface 224 for presenting visual analytics GUI objects 174 to analyst users. In some embodiments, the visual analytics interface 224 may include interactive functions for interacting with the visual analytics GUI objects 174 and/or to generate visualization requests 146. The GUI interface component 216 may operate to generate visual analytics GUI objects 174 formed from the transformation and conversion of metrics information 152 into interactive GUI objects that support visualization and analysis of metrics information 152.

The visual analytics GUI objects 174 may operate to allow analyst users to efficiently and effectively visualize large and complex data and behavior patterns resulting from user interaction with a platform application 140. The visual analytics GUI objects 174 may facilitate human-information discourse and meaningful information exchanges with the vast amounts of metrics information 152 available for a platform application 140 that provides an improvement of information access and analysis techniques using conventional technologies. In some embodiments, the visual analytics GUI objects 174 may be analyzed by analyst users to determine one or more conclusions, For example, a conclusion may include a determination of a platform user behavior and/or platform application 140 functionality. In another example, a conclusion may include a report generated by a researcher to confirm or falsify a hypothesis regarding platform user behavior and/or platform functionality put forth by platform designer. In another example, a conclusion may include a behavior analysis report of new design features, updates, and/or the like of the platform application.

In some embodiments, the GUI interface component 216 may include a map GUI component 218a and a network GUI component 218b. The map GUI component 218a may generally operate to generate map GUI objects 176 based on metrics information 152 and/or a visualization request 146. For example, the map GUI component 218a may operate to generate map GUI objects 176 based on spatial constraints (e.g., heat maps focused on a specified area of the application environment), time constraints (e.g., an event map depicting events that occurred during a specified time period), Boolean expressions and/or set expressions (e.g., an event map depicting locations of occurrences of a first action and a second action, an event map depicting the symmetric difference of a first set of events and a second set of events, and/or the like), and/or the like. For example, the map GUI component 218a may receive a first visualization request 146 to visualize platform user movement within an application environment within the first ten minutes of user interaction with the platform application 140. In response to the first visualization request 146, in some embodiments, the map GUI component 218a may generate a map GUI object 176 that includes a heat map of user movement only within the first ten minutes of user interaction with the platform application 140. In another example, the map GUI component 218a may receive a second visualization request 146 to visualize the intersection (e.g., Boolean “AND” operation) of a first event and a second event within an application environment (e.g., locations on the application environment where the first event and the second event occur together or are performed together by the same platform user). In response to the second visualization request 146, in some embodiments, the map GUI component 218a may generate a map GUI object 176 that includes an intersection event map depicting locations of the intersection of the first event and the second event. In some embodiments, the intersection event map may include a heat map with event GUI objects depicting locations of the intersection of the first event and the second event superimposed over movement GUI objects depicting user movement.

in general, the network GUI component 218b may operate to generate network GUI objects 178 formed using state networks 156 and/or sequence networks 158. State networks 156 are highly informative for analysis of platform user interaction with a platform application 140. However, even for relatively small data sets, conventional state networks often become too complex and cluttered with node and link objects to allow for efficient insightful analysis. Consequently, the ability to track and/or compare multiple traces through a software application is limited. For example, it is difficult, time consuming, and/or not possible to make certain determinations using state networks and/or sequence networks using conventional technologies, such as questions relating to the uniqueness and/or commonality of state and/or sequence patterns e.g., the top ten most popular sequences, comparison of frequent losing patterns with frequent winning patterns). Techniques, such as edge bundling, have been used to simplify conventional state networks; however, such techniques reduce or completely eliminate the ability to analyze certain user behaviors, such as individual strategies. Therefore, the usefulness of conventional state networks and sequence networks is insufficient to efficiently and effectively analyze user data.

In some embodiments, the network GUI component 218b may be configured to provide for the synchronized visualization of a state network 156 and a corresponding sequence network 158 within a single visual analytics interface 224. Accordingly, the synchronized visualization function may provide for the efficient comparison of moment-to-moment data of user interaction with a platform application 140. In some embodiments, the network GUI component 218b may present the state network 156 immediately adjacent to the corresponding sequence network 158 for synchronized visualization of states, sequences, and/or the like. In some embodiments, the synchronized visualization function of the network GUI component 218b may operate to provide synchronized interaction with a state network 156 and the corresponding sequence network 158. For instance, selection of a node in a sequence network 158 may cause the network GUI component 218b to highlight the corresponding sequence of nodes in the corresponding state network 156. In one example, a visualization request 146 may include a query about a particular sequence and the network GUI component 218b may operate to highlight the sequence node in the sequence network 158 and the behavior sequence (e.g., the sequence of state nodes and links) in the corresponding state network 156.

In some embodiments, the GUI interface component 216 may be configured to generate behavior information 226 by determining insights into platform user behavior based on the metrics information 152 presented in the visual analytics GUI objects 174. In some embodiments, the behavior information 226 may be generated in response to a visualization request 146. For example, an analyst user may transmit a visualization request 146 to view a map GUI object 176 depicting the intersection (e.g., Boolean “AND” expression) of a first event and a second event. In response to the visualization request 146, the map GUI component 218a may generate a map GUI object 176 graphically depicting the intersection of the first event and the second event. In some embodiments, the GUI interface component 216 may analyze the request using the metrics information 152 to determine behavior information 226 relating to the first event, the second event, the intersection of the first event and the second event, and/or combinations thereof. For example, the behavior information 226 may present a determination that the intersections of the first event and the second event are only performed by experienced users, are only performed by users that complete a certain sequence, and/or the like. In some embodiments, the behavior information 226 may include information entered into the visual analytics system as behavior information 226 by analyst users. For example, an analyst user may determine platform user behaviors based on an analysis of the visual analytics GUI objects 174 and may enter the platform user behaviors into the visual analytics system as behavior information 226. Embodiments are not limited in this context.

FIG. 3A illustrates an embodiment of an operating environment 300 for the visual analytics system 100. More particularly, the operating environment 300 may illustrate a visual analytics interface 224 presented on the display 180 of an electronic device 105b. Although a game application is used as an illustrative platform application 140 in FIG. 3A, embodiments are not so limited. Non-limiting examples of platform applications 140 may include a mobile app, a web site, an e-commerce web site, a productivity application, an electronic program guide, a database application, and/or the like. Embodiments are not limited in this context.

In the illustrative embodiment depicted in FIG. 3A, the visual analytics interface 224 may present a map GUI object 176 of a portion of an application environment 305 encountered by platform users of a platform application 140. For example, the application environment 305 may include a portion of a virtual environment of a game application having various structures, such as buildings 310a-d and pathways 310e-g. The map GUI object 176 may include a movement GUI object (a “heat map” GUI object) 315 depicting the movement of players (e.g., character objects controlled by platform users) within the application environment 305. The heat map GUI object 315 may be configured to indicate the frequency of user movement using various color, shading, and/or the like schemes to depict different levels of movement. For example, as indicated in a heat map legend GUI object 340, the heat map GUI object 315 may indicate no movement (e.g., no shading, coloring, and/or the like), low movement 346, medium movement 344, high movement 342, and/or the like. The map GUI object 176 may include player paths 320 through the application environment 305. Although FIG. 3A depicts multiple player paths 320, only one is labeled to simplify the figure.

The visual analytics interface 224 may include various interactive selection GUI objects for analyst users to interact with the map GUI object 176 and/or metrics information 152. For example, a user may select an object depicted on the map GUI object 176, such as an event, a location, a player pay 320, a heat map GUI object 315 and/or the like and the visual analytics interface 224 may present access to the metrics information 152 (e.g., metrics information records) associated with the selection.

An event selection GUI object 325 may allow for the selection of events to be displayed on the map GUI object 176. In general, an event may include any definable, measurable, and/or discrete occurrence that may transpire within a platform application 140. Non-limiting examples of events may include actions, object selections, input cursor hovering, navigation selections, fights, kills, purchases, asset acquisitions (e.g., lives, weapons, armor, and/or the like), asset changes (e.g., changing weapons, vehicles, and/or the like), tasks, task completion, NPC interaction, dialog, sequence initiation/completion, and/or the like. In some embodiments, the visual analytics application 150 may include one or more pre-defined events. In some embodiments, an analyst user may define an event. For example, an analyst user may define a “backtrack” event that occurs when a platform user moves back (e.g., retraces) over a previous path. As shown in the event selection GUI object 325 of FIG. 3A, Event A, Event B, and Event D have been selected. Accordingly, event icon GUI objects A, B, and D are depicted on the map GUI object 176 in the location of the application environment 305 where the corresponding events have occurred according to the metrics information 152.

The visual analytics interface 224 may include a player selection GUI object 330 to allow an analyst user to select players for display on the map GUI object 176. In general, a player may include any definable player, NPC, component (e.g., vehicle, weapon, currency, and/or the like) that exists within a platform application 140. In some embodiments, the visual analytics application 150 may include one or more pre-defined players. In some embodiments, an analyst user may define a player, for example, for selection within the player selection GUI object 330. For instance, an analyst user may define a particular weapon or vehicle to see how these components are used and/or move within the application environment 305 of a game application during gameplay. As shown in the player selection GUI object 330 of FIG. 3A, Player 1 and Player 2 have been selected. Accordingly, movement paths 320 for 1 and 2 are depicted in the map GUI object 176.

The visual analytics interface 224 may include a population selection GUI object 355 to allow an analyst user to select a population for the display of heat map GUI object 315 movements and/or events. In general, a population may include a set of players, components, and/or the like. Non-limiting examples of populations may include all platform users, experienced platform users, novice platform users, platform users exhibiting a particular strategy, a specified category of platform users, platform users having certain demographic characteristics (e.g., age, gender, income, geographic location, education, and/or the like), platform user personality profiles, and/or the like. For example, an analyst user may use the population selection GUI object 355 to limit the heat map GUI object 315 to only depict movements associated with a specific population. In another example, an analyst user may use the population selection GUI object 355 to limit the map GUI object 176 to only display the selected events for a particular population. In some embodiments, the visual analytics application 150 may include one or more pre-defined populations. In some embodiments, an analyst user may define a population, for example, for selection within the population selection GUI object 355.

In some embodiments, the visual analytics interface 224 may allow for a visualization request 146 involving the spatial limitation of the map GUI object 176 to a specific region, structure, or other area of the application environment 305. As shown in FIGS. 3B and 3C, the map GUI object 176 depicts structure 310a and a portion of pathway 310e. The visualization request 146 visualization request 146 selecting an area of the application environment 305 may be performed using various functions including, without limitation, input device selection of the area, specifying area coordinates, entry of an area name (e.g., structure 310a, purchase page, and/or the like), and/or the like. The visualization request 146 may be received by the visualization application 150, such as through the GUI visualization component 216 (and/or a component thereof) to implement the request.

In some embodiments, the visual analytics interface 224 may include a time selection GUI object 345 operative to allow an analyst user to perform a visualization request 146 specifying a time period of metrics information 152 to be displayed by the map GUI object 176. For example, the time selection GUI object 345 may include a start time element 350a for specifying a start time of the time period of interest and an end time element 350b for specifying an end time of the time period of interest. Accordingly, an analyst user may focus only on metrics information 152 within a specific time period, which would otherwise be covered, obfuscated, obscured, or otherwise non- intelligible using conventional technologies. The visualization request 146 may be received by the visualization application 150, such as through the GUI visualization component 216 (and/or a component thereof) to implement the request.

FIGS. 3B and 3C depict the map GUI object 176 of FIG. 3A for a particular location of interest and a time period of interest. As shown in FIGS. 3B and 3C, the map GUI object 176 depicts the structure 310a and a portion of the pathway 310e as the location of interest. The start time element 350a and the end time element 350b of the time selection GUI object 345 have been positioned to specify a first time period 370a in FIG. 3B. Accordingly, the map GUI object 176 of FIG. 3B depicts a heat map GUI object 315 that only graphically represents platform user movement during the first time period 370a. In addition, the map GUI object 176 of FIG. 3B only depicts events (e.g., event icon GUI objects A and B) that occurred during the first time period 370a. As shown in FIG. 3C, the start time element 350a and the end time element 350b of the time selection GUI object 345 have been positioned to specify a second time period 370b. Accordingly, the map GUI object 176 of FIG. 3C depicts a heat map GUI object 315 that only graphically represents platform user movement during the second time period 370b. In addition, the map GUI object 176 of FIG. 3C only depicts events (e.g., event icon GUI objects B) that occurred during the second time period 370b.

In this manner, the particular events and/or movements within a specific time period may be visualized separately from the entirety of events and/or movements within the metrics information 152 for visualization and analysis. For example, the map GUI object 176 of FIG. 3A depicts that Event A has occurred three times and that Event B has occurred three times in structure 310a. In addition, the heat map GUI object 315 of FIG. 3A depict a first movement area 380a and a second movement area 380b within structure 310a. As depicted in FIG. 3B, the map GUI object 176 depicting metrics information 152 that occurred within the first time period 370a reveals that Event A has occurred three times and Event B has occurred once during the first time period 370a. As depicted in FIG. 3C, the map GUI object 176 depicting metrics information 152 that occurred within the second time period 370b reveals Event B has occurred twice during the second time period 370b. A comparison of the heat map GUI object 315 of FIGS. 3B and 3C reveals that the movement that occurred in structure 310a in the first movement area 380b occurred during the first time period 370a. A comparison of the heat map GUI object 315 of FIGS. 3B and 3C also reveals that movement within the second movement area 380a occurred during both the first time period 370a and the second time period 370b, with the vast majority of the movement occurring during the second time period 370b. In some embodiments, the time selection GUI object 345 (or other GUI object) may be used to allow for replaying one or more play traces.

In some embodiments, the presentation of different map GUI objects 176 created by the selection of areas of a location of interest and/or a time period of interest may be synchronized to allow for simultaneous visual analysis of the metrics information 152 depicted in the different map GUI objects 176. For instance, the map GUI objects 176 of FIG. 3A, FIG. 3B, and/or FIG. 3C may be depicted adjacent to each other for an efficient visual comparative analysis.

The visualization of metrics information 152 through the map GUI objects 176 allows for, among other things, a more efficient analysis of the metrics information 152 as well as a deeper understanding of platform user behavior that provides a marked improvement over existing technologies. The map GUI objects 176 created via manipulation of the time selection GUI object 345 allow for novel insights into platform user behavior. For example, a comparison of the map GUI objects 176 of FIG. 3A, FIG. 3B, and/or FIG. 3C indicates that platform users entering the structure 310a during the first time period 370a (e.g., during the first ten minutes of gameplay) are mostly active in Event A and mostly proceed in the direction of movement area 380b. In another example, a comparison of the map GUI objects 176 of FIG. 3A, FIG. 3B, and/or FIG. 3C indicates that platform users entering the structure 310a during the second time period 370a (e.g., from ten minutes to thirty minutes of gameplay) are active in Event B and mostly proceed in the direction of movement area 380a.

In these examples, Event A may involve accessing an asset (e.g., coins) which may be located within movement area 380b and Event B may involve performing a task within movement area 380b (e.g., fighting an NPC). An analyst user (e.g., game developer or game researcher) may analyze the visualized metrics information 152 depicted in the map GUI objects 176 of FIG. 3A, FIG. 3B, and/or FIG. 3C to deduce behavior information 226. In some embodiments, the visual analytics application 150 may analyze the visualized metrics information 152 depicted in the map GUI objects 176 of FIG. 3A, FIG. 3B, and/or FIG. 3C to deduce behavior information 226. For example, the movement and event patterns depicted in FIGS. 3A may indicate behavior information 226 that users are concerned with obtaining assets, resources, and/or the like during the initial stages of gameplay and typically avoid performing tasks that may use up their resources until later in the game (e.g., when they have sufficient resources). Accordingly, spatial and temporal constraints on metrics information 152 depicted in map GUI objects 17 may reveal behavior patterns that cannot be discovered using conventional technologies.

Referring to FIG. 3A, the visual analytics interface 224 may include a compound map selection GUI object 360 to allow an analyst to enter a visualization request 146 to generate compound map GUI objects (see, for example, FIG. 3F). In general, a compound map GUI object depicts metrics information 152 of a plurality of events, players, locations, populations, application components, strategies, and/or the like in one or more relationships. In some embodiments, the relationships may be expressed as Boolean expressions (e.g., and, or, not, nor, and/or the like) and/or set expressions (e.g., intersection, union, symmetric difference, relative complement, absolute complement, and/or the like). In some embodiments, the compound map selection GUI object 360 may include various GUI objects for forming compound relationships, query expressions, and/or the like for generating compound GUI map objects. The compound map selection component object 360 may allow analyst users to generate visualization request 146 to form complex queries in an efficient and accurate manner using visual GUI objects.

The compound map selection GUI object 360 may include an event selection GUI object 362 for selecting one or more events, a player selection GUI object 364 for selecting one or more players, a compound event selection GUI object 366 for selecting pre-defined compound events, a relationship selection GUI object 368 for selecting a relationship between events, players, and/or the like. In some embodiments, the compound map selection GUI object 360 may include various other GUI objects for forming any type of relationship, query expression, and/or the like according to some embodiments. The embodiments are not limited in this context.

FIG. 3F depicts a map GUI object 176 in the form of a compound map GUI object 390 for the intersection of events A and D (e.g., Event B ∩ Event D) (or the Boolean expressions “Event B AND Event D”) within the application environment 305. For example, an analyst user may have selected a “Compound Event A and D” GUI object from the compound map selection GUI object 360 and an “AND” or “intersection (∩)” relationship from the relationship selection GUI object 368. FIG. 3D depicts a map GUI object 176 depicting a heat map GUI object 315 and event icon GUI object B for Event B and FIG. 3E depicts a map GUI object 176 depicting a heat map GUI object 315 and event icon GUI objects D for Event D. FIG. 3F depicts a compound GUI object 385 where both Event B and Event D have occurred together or otherwise coincide. In some embodiments, the event icon GUI objects for Event B and Event D may be displayed instead of or in addition to the compound GUI object 385. In general, a compound event may be indicative of a certain event or action that, for instance, is not directly triggered by the individual events alone. For example, in an RPG game application a secret retrieval action (e.g., “pick-pocketing” or otherwise obtaining an asset while being undetected by NPCs and/or other platform users) may require that a platform user initiate both a “sneaking” action (e.g., an attempt to move undetected by NPCs or the like) and an “item interaction” action (e.g., attempting to pick up an item) simultaneously, substantially simultaneously, and/or within a location and/or time threshold. If a platform user is “sneaking” without simultaneously, substantially simultaneously, and/or within a location and/or time threshold performing an “item interaction,” or vice versa, the platform user is not attempting a secret retrieval action. If, for example, Event B is a “sneaking” action and Event D is an “item interaction” action, an analysis of the event icon GUI objects B and D in the map GUI object 176 of FIG. 3A will not reveal secret retrieval actions. The map GUI object 390 depicted in FIG. 3F provides visual representation of secret retrieval actions 385 via graphically representing the intersection of Event A and Event D (e.g., A ∩ D) (or the Boolean expressions “Event A AND Event B”) within the application environment 305.

Although the compound map GUI object 390 depicted in FIG. 3F involved compound events, embodiments are not so limited as a compound map GUI object may be generated for any information, object, and/or the like within the metrics information 152. For example, a compound map GUI object 390 may be generated to visualize a set expression or Boolean expression for players, populations, assets, locations, strategies, combinations thereof, and/or the like. For example, a compound map GUI object 390 may be generated to visualize areas of the application environment 305 that are not visited by novice users (e.g., the Boolean expression “not novice users”). In another example, a compound map GUI object 390 may be generated to visualize one or more certain events carried out by players having one or more specified characteristics, including, without limitation, players exhibiting a certain strategy (e.g., avoidance, confrontation, aggressive, and/or the like), players associated with a certain asset (e.g., a weapon, a vehicle, and/or the like), players that have performed a task, and/or the like. In some embodiments, the compound map GUI objects 390 may be configured to depict features of interest, including, without limitation, players, events, populations, a time period, and/or a location of interest, as described in reference to FIG. 3A-3C. For instance, a compound map GUI object 390 may be generated to visualize areas of the application environment 305 that are not visited by novice users within the first twenty minutes of gameplay. In another instance, in an e-commerce website application, a compound map GUI object 390 may be generated to visualize the browsing pattern of users that make a purchase within five minutes of visiting the website.

In some embodiments, compound map selection GUI object 360 may allow for analyst users to generate query requests. For example, an analyst user may generate various spatial analysis query requests, such as map accessibility queries (e.g., where do players spend the most time?, which areas of a level are underutilized (e.g., which areas are used below a threshold amount?), event location queries (e.g., where to players spend the most time interacting with game objects?, where do players often perform special events, such as accessing inventor or reloading a weapon?), combined event questions (e.g., where do players interact with NPCs while perform a specific action?). In some embodiments, the query results may be visualized via the map GUI object 376 and/or compound map GUI object 390.

The map GUI objects 176 and compound map GUI objects 390 depicted in FIGS. 3A-3F make improvements over existing technologies, for example, by providing for efficient visual analysis of individual and/or sub-population play traces (including movement and event information), including for discrete, analyst-defined time periods. The map GUI objects 176 and compound map GUI objects 390 allow an analyst user to perform analysis and form conclusions beyond population behaviors, for instance, by allowing for the performance of individual platform user trace analysis that are not available using conventional technologies and visual graphics.

FIG. 4A illustrates an embodiment of an operating environment 400 for the visual analytics system 100. More particularly, the operating environment 400 may illustrate a visual analytics interface 224 presented on the display 180 of an electronic device 105b. Although a game application is used as an illustrative platform application 140 in FIG. 4A, embodiments are not limited in this context.

As depicted in FIG. 4A, a visual analytics interface 224 may be configured to present one or more network GUI objects 178. For example, the visual analytics interface 224 may present a state network GUI object 405 and a sequence network GUI object 430. The state network GUI object 405 may include a plurality of nodes 410a-j connected via one or more links 415. Although a plurality of links 415 are depicted in FIG. 4A, only one link 415 is labeled to simplify the figure. In some embodiments, each node 410a-j may be configured to graphically represent a state of the platform application 140. In general, a state may be associated with a situation, condition, position, and/or other status of the platform application 140, a platform user, and/or object as the platform user progresses through the platform application. Each state may be associated with metrics information 152 that defines the state. In some embodiments, a node information GUI object 425 may be configured to present metrics information 152 associated with a selected node 410a-j, links 415, and/or node 420a-v. Non-limiting examples of metrics information 152 presented on the node information GUI object 425 may include a user identifier, a state node, an action link, a sequence, dialog, entities, assets, metrics information records associated with the node, link, or sequence of nodes, number of players traversing the node, and/or the like. The node information GUI object 425 may be used for other objects within a state network GUI object 405 or a sequence network GUI object 430, such as links 415.

In some embodiments, a state may include metrics information 152 associated with in-application entities (e.g., NPCs, resources, components, location, dialog, and/or the like) that may affect a platform user's choice of action. In a non-limiting FPS game application example, a state may include metrics information 152 that includes a platform user's current position, health level, wielded weapon, carried item(s), and information regarding nearby NPCs. In a non-limiting example game application that includes dialog-based choices, a state may be associated with dialog from an NPC directed toward a platform user requiring that the user make a decision. For instance, the dialog may be a request to perform a task and the platform user may decide whether or not to accept the request and attempt to complete the task. Embodiments are not limited in this context.

In some embodiments, one or more of the states may be pre-defined (e.g., start of gameplay, completion of a level, dialog, task location, and/or the like). In some embodiments, one or more of the states may be defined by an analyst user. In some embodiments, one or more of the states may be determined based on user interaction with the platform application 140 (e.g., the visual analytics application 150 may generate states and/or nodes 410a-j based on certain characteristics of user interactions, such as frequency of user interactions, frequent starting/stopping points, frequent roadblocks to progressing through tasks, the application environment, frequent location and/or condition associated with one or more events, and/or the like). In some embodiments, the state network GUI object 405 may include a directed graph having, for example, directed links 415.

The nodes 410a-j may include various node properties visually indicating information associated with the nodes 410a-j. Non-limiting examples of properties may include size, color (and/or shading), opacity, location, shape, distance from other nodes 410a-j, border thickness, border color, and/or the like. Information indicated by the node properties may include starting nodes, ending nodes (e.g., completion of a task, completion of a level, completion of a game, a purchase, and/or the like), high difficulty nodes (e.g., states that are completed by a relatively low number of platform users), low difficulty nodes, node identifier (e.g., pre-defined identifiers), and/or the like. For example, shaded node 410a may be a starting node and shaded node 410f may be an ending node (e.g., game or level completion state). The links 415 may include various link properties visually indicating information associated with the links 415. Non-limiting examples of properties may include thickness, color, and/or the like. For example, the thickness of a link 415 may indicate a frequency that platform users traverse of the link 415.

The positions and/or distances between the nodes 410a-j may be determined using various processes. In some embodiments, the positions and/or distances between the nodes 410a-j may be determined using force-directed placement. In embodiments using force-directed placement, the network GUI component 218b may generate the state network GUI object to place nodes 410a-j that are highly connected close by each other and nodes 410a-j that are less connected farther apart. Accordingly, groups of highly connected nodes 410a-j may denote actions and/or states that are similar or substantially similar such that, for example, the actions and/or states may appear interchangeable or substantially interchangeable in a sequence (e.g., play trace).

As shown in FIG. 4A, the visual analytics interface 224 may include a network GUI object 178 in the form of a sequence network GUI object 430. In some embodiments, the sequence network GUI object 410 may include a plurality of nodes 420a-v. In some embodiments, the nodes 420a-v may be configured to represent a sequence of states. In some embodiments, one or more of the nodes 420a-v may represent a complete use sequence (e.g., a play trace) of one or more platform users during interaction with the platform application 140.

The nodes 420a-v may include various node properties visually indicating information associated with the nodes 420a-v. Non-limiting examples of properties may include size, color (and/or shading), opacity, location, shape, distance from other nodes 420a-v, border thickness, border color, and/or the like. Information indicated by the node properties may include popularity rank, completed sequences, non-completed sequences, sequence strategy, sequence identifier (e.g., identifier for pre-defined sequences), and/or the like. For example, node 420a is the largest node and, accordingly, represents the most popular sequence (e.g., play trace). In another example, non-shaded nodes 420a-o may indicate completed sequences, and shaded nodes 420p-v may indicate non-completed sequences. As indicated by the distance between certain of the completed nodes 420a-o and the non-completed nodes 420p-v in the sequence network GUI object 430, certain of the completed nodes 420a-o are substantially similar to certain of the non-completed nodes 420p-v. In some embodiments, a node 420a-u may be associated with one or more labels configured to indicate information about the node 420a-u and/or the associated sequence. For instance, each node 420a-u may be labeled to indicate the popularity rank of the associated sequence.

In some embodiments, the difference between sequences represented by the nodes 420a-v may be proportional and, for example, may indicate the difference between sequences. For example, a greater distance between nodes 420a-v may indicate a greater difference between the sequence represented by the nodes 420a-v, and vice versa. The distance between the nodes 420a-v may be determined using various processes. In some embodiments, the distance between the nodes 420a-v may be determined, at least in part, using dynamic tree warping (DTW). In general, DTW is a technique configured to determine a numeric distance between sequences of different lengths. DTW non-linearly “warps” the sequences to find an optimal path to match between sequenced items. In some embodiments, to determine sequence dissimilarity, the DTW process may use a metric function to compare application states d(s₁, s₂) for all pairs s₁, s₂ of states. In some embodiments, the metric function may operate to represent states as numeric vectors. Non-limiting examples of such metric functions may include Euclidean distance and Manhattan distance.

In some embodiments, the DTW process may be selected based on one or more characteristics of the platform application. For example, for a puzzle game application having a relatively static environment and/or a dialog-based game application, the network GUI component 218b may use an “action-based” state difference process. In some embodiments, the action-based state difference process may determine the state difference d(s₁, s₂) of state s₁ and s₂ to be the smallest number of actions required to transform from s₁ to s₂, and vice versa. In some embodiments, if there is not a way to transform from s₁ to s₂, d(s₁, s₂) may be set to infinity (or a maximum value, such as maximum sequence length). The more actions required to transform from s₁ to s₂, the greater the difference between s₁ and s₂. Following a determination of state difference d(s₁, s₂), the DTW process may determine sequence differences using dynamic programming.

In some embodiments, the DTW process may include a minimum edit distance process in which using d(s₁, s₂) as the difference of any state pair s₁ and s₂, the difference D(a, b) of two sequences a={s₁, s₂, . . . , sₙ} and b={q₁, q₂, qₙ}may be determined as D(n, m) according to the following: (1) initialization: (a) D(0, 0) =0, (b) for i in [1, n] and j in [1, m], D(i, 0) =D(0, j)=infinite value (or maximum value); (2) recursion: for i=1 to n and j=1 to m, D(i, j)=D(sᵢ, qᵢ) +min[D(i−1, j), D(i, j−1), D(i−1, j−1)]; and (3) return: D(n, m).

In the initialization step, D(0, 0) may represent the distance of empty sequences valued as 0. In some embodiments, D(i, 0) and D(0, j) may represent the distance between an empty sequence and a non-empty sequence, which may be set to an infinite value, indicating that non-empty sequences are inherently different from empty ones. In some embodiments, the infinite distance value may be replaced by a large number that exceeds the length of all possible sequences. In the recursion step, the distance value may be the smallest among three alternatives, including, without limitation insertion (e.g., D(i−1, j)), deletion (e.g., D(i, j−1)), and match (e.g., D(i−1, j−1)). Accordingly, in some embodiments, the DTW process may be configured as a generalization of minimum edit distance, for example, in which state comparison metric replaces simple matching operations.

In some embodiments, sequence distance values may be encoded as link length in a force-directed graph, such that clustering of similar nodes may occur, as similar nodes clump together. As such, sequence nodes farther away indicate that the behaviors exhibited are different. The encoding of node dissimilarity as link lengths in a force-directed graph may be equivalent to a metric multidimensional scaling layout. Accordingly, such multi-dimensional scaling techniques may be used to generate sequence network GUI objects 430.

As depicted in FIG. 4A, the network GUI component 218b may operate to provide a synchronized visualization of a state network GUI object 405 and a corresponding sequence network GUI object 430 within a single visual analytics interface 224. For instance, in some embodiments, the network GUI component 218b may present the state network GUI object 405 immediately adjacent to the corresponding sequence network GUI object 430 for synchronized visualization of states, sequences, and/or the like. In this manner, an analyst user may interact with metrics information 152 in different levels of granularity simultaneously and using a common interface while also being able to visualize relationships between the visualized metrics information 152, In addition, the synchronized visualization functionality may allow analyst users to form complex queries (e.g., as visualization requests 146) regarding states and sequences in an efficient and accurate manner using visual GUI objects which provides an improvement over conventional technologies. Furthermore, the uniqueness and/or commonality of state and/or sequence patterns (e.g., the top ten most popular sequences, comparison of frequent losing patterns with frequent winning patterns) may be efficiently and effectively visualized to allow an analyst user to determine such conclusions in a manner that provides an improvement over conventional technologies.

In some embodiments, the synchronized visualization function of the network GUI component 218b may operate to provide synchronized highlighting of GUI objects in a state network GUI object 405 and a corresponding sequence network GUI object 430. The highlighted GUI objects may be determined based on a visualization request 146, for example, entered as a query and/or by selecting GUI objects (such as a state 410a-j, a link 415, and/or sequences 420a-v). The visualization request 146 may be received by the visualization application 150, such as through the GUI visualization component 216 (and/or a component thereof) to implement the request.

As shown in FIG, 4B, a sequence 435a of nodes 410a-f has been selected and highlighted in the state network GUI object 405. In the example depicted in FIG. 4B, the sequence 435a has been highlighted to differentiate the sequence 435a from the other, non-selected sequences in the state network GUI object 405. The synchronized highlighting function may operate to highlight the corresponding node 440a in the sequence network GUI object 430. In some embodiments, selection of a node 420a in the sequence network GUI object 430 may operate to highlight the corresponding sequence 435a in the state network GUI object 405. In some embodiments, the non-highlighted nodes in the sequence network GUI object 430 may be removed or rendered less visible when a node 440a is highlighted in the sequence network GUI object 430. Accordingly, an analyst user may select a sequence 435a depicting metrics information 152 at a first level of granularity in a state network GUI object 405 and visualize a highlighted node 440a graphically representing the sequence in a second level of granularity in a. sequence network GUI object 430 simultaneously, and vice versa. Referring to FIG. 4C, multiple sequences 425a, 425b may be selected in the state network GUI object 405 and the corresponding nodes 440a, 440b may be highlighted in the sequence network GUI object 430, and vice versa.

As shown in FIG. 4B, the visual analytics interface 224 may provide for various synchronized visualization analyses. For instance, using the sequence network GUI object 430, an analyst user may select the most popular sequence (e.g., sequence 420a). In addition, the analyst user may visually determine sequences that are different and/or similar to the most popular sequence based on the distance therefrom. Simultaneously and using the same interface (e.g., the visual analytics interface 224), the analyst user may analyze the moment-to-moment) state-action of one or more selected sequences (e.g., selected nodes 420a-v). For example, the analyst user may observe the discrepancy between two sequences and evaluate the difference. In addition, the analyst user may observe the individual metrics information 152 records of the two sequences to, for example, form a conclusion explaining the difference between the two sequences.

In some embodiments, selection of one or more nodes 410a-j and/or links 415 may cause the network GUI component 218b to highlight each node 420a-v that has a sequence that includes the selected node 410a-j and/or link 415. In some embodiments, selection of a node 420a-v may cause the network GUI component 218b to highlight each node 410a-j and/or link 415 included in the sequence represented by the node 420a-v.

In some embodiments in which one or more of the nodes 410a-j are associated with a particular event, such as dialog, selection of a node 410a-j and/or sequence thereof may cause a trace GUI object to be presented on the visual analytics interface 224 to allow an analyst user to view the corresponding trace of events and/or dialog (e.g., an event trace or a dialog trace). In some embodiments, the trace GUI object may graphically represent the event and/or dialog associated with each selected node 410a-j. In some embodiments, multiple sequences of nodes 410a-j may be selected (see, for example, FIG. 4C). In such embodiments, the trace GUI object may graphically present a corresponding event trace and/or dialog trace for each sequence. In some embodiments, visualization of the plurality of event traces and/or dialog traces may be synchronized to allow for the simultaneous visualization and analysis of the event traces and/or dialog traces. For example, the event traces and/or dialog traces for each selected node (and/or sequence of nodes) 410a-j, including nodes 410a-j selected via selection of a node 420a-v of a corresponding sequence network GUI object 430, may be presented adjacent to each other to allow for synchronized visualization and analysis.

In some embodiments, the synchronized visualization function may include state network GUI objects 405, sequence network GUI objects 430, and/or map GUI objects 176. As shown in FIG. 4D, a network GUI object 178, such as a state network GUI object 405, may be depicted on a visual analytics interface 224. One or more sequences 425a, nodes 410a-j, links 415, and/or the like may be selected on the state network GUI object 405. A corresponding map GUI object 176 may be presented on the visual analytics interface 224 adjacent to the state network GUI object 405. Metrics information 152 corresponding to the selected sequence 425a, node 410a-j, link 415, and/or the like may be depicted on the map GUI object 176. For example, a path 435 through the application environment 305 that is traversed when performing the selected sequence 425a may be depicted on the map GUI object 176. In another example, a heat map GUI object 315 corresponding to platform users that have performed the sequence within the platform application 140 may be depicted on the map GUI object 176. In a further example, event icon GUI objects A, B, and D for events that occur when platform user perform the selected sequence 425a may be presented on the map GUI object 176. In a still further example, locations on the map GUI object 176 where a selected state 410a-f occurs may be graphically represented on the map GUI object 176. Accordingly, an analyst user may simultaneously visualize and analyze metrics information 152 interactively in a plurality of formats, such as a graph or network format and a map format, which is not possible using conventional technologies.

In some embodiments, an analyst user may enter a query, for example, via the query GUI object and have the query results returned as map GUI objects 176 and/or network GUI objects 178. For example, an analyst user may enter a query to analyze one or more play traces involving a certain strategy (e.g., an avoidance strategy, a compliance strategy, and/or the like). The visual analytics application 150 may return the query results as a state network GUI object 405 presented adjacent to a corresponding map GUI object 176 for play traces involving the strategy.

The state map GUI objects 405 and the sequence map GUI objects 430 depicted in FIGS. 4A-4D may allow for the efficient and effective dialog choice analysis for game applications using dialog conversations. Dialog analysis may allow for insight into player behavior that cannot be determined using spatial analysis of metrics information 152. For example, in certain dialog, a player may be requested to undertake a challenge that is heroic in nature (e.g., engaging an enemy). Players who accept such challenges may be more engaged in the game application than those who do not accept the challenge. In some embodiments, the visual analytics interface 224 may allow for analyst users to generate query requests relating to the information depicted by the state map GUI objects 405 and the sequence map GUI objects 430. For example, the queries may include population behavior queries, such as determining the most common dialog traces. Such a query may be determined, for instance, by selecting the nodes 420a-v of the most popular sequences and analyzing the sequence of nodes 410a-j and/or trace GUI object of the corresponding dialog trace in the state network GUI object 405. In another example, the queries may include individual behavior queries, such is commonality of a player's dialog choice. Such a query may be determined, for instance, by entering in a player identifier to highlight nodes 420a-v and/or nodes 410a-j associated with the player to see the popularity of sequences associated with the player identifier. In a further example, the queries may include behavior comparison queries, such as the differences between two dialog traces. Such a query may be determined, for instance, by entering the player identifiers to highlight nodes 420a-v and/or nodes 410a-j associated with the player and to analyze the particular sequences and/or trace GUI objects associated with the players. In some embodiments, the visual analytics interface 224 may include a query GUI object configured to allow an analyst user to enter query text (e.g., difference between dialog trace of player 1 and player 2; difference between event traces of players that complete level 1 versus those that quit before completing level 1). The query results may be visually represented using the state map GUI objects 405 and the sequence map GUI objects 430, for example, by highlighting the query results as described according to some embodiments.

Included herein is a set of flow charts representative of exemplary methodologies for performing novel aspects of the described technology according to some embodiments. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation

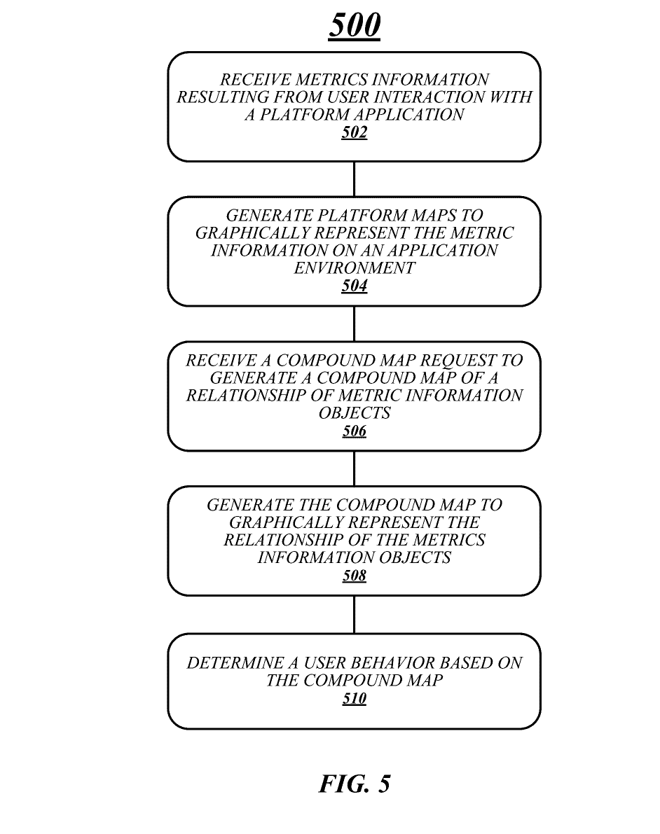

FIG. 5 depicts an illustrative logic flow according to a first embodiment. More specifically, FIG. 5 illustrates one embodiment of a logic flow 500. The logic flow 500 may be representative of some or all of the operations executed by one or more embodiments described herein. For example, the logic flow 500 may illustrate operations performed by the visual analytics system 100.

In the illustrated embodiment shown in FIG. 5, the logic flow 500 may receive metrics information at block 502. For example, the visual analytics application 150 may generate, receive, or otherwise access metrics information 152 associated with one or more platform applications 140. The metrics information 152 may be generated based on user interactions with a platform application 140. For example, the metrics information 152 may include records storing data relating to actions performed by platform users within the application environment of a platform application 140.

The logic flow 500 may generate platform maps to graphically represent the metric information on an application environment at block 504. For example, the visual analytics application 150 may present a visual analytics interface 224 that provides a map GUI object 176. The map GUI object 176 may include a movement map (or “heat map”) that includes a heat map GUI object 315 graphically depicting the movement of platform users through an application environment 305. The GUI object 176 may include an event map that includes event icon GUI objects (such as event icon GUI objects A and B depicted in FIG. 3A) graphically representing the occurrence of events superimposed onto the application environment 305 where the events occurred.

The logic flow 500 may receive a compound map request to generate a compound map of a relationship of metric information objects at block 506. For example, the map GUI component 218a may receive a request via a compound map selection GUI object 360 depicted on the visual analytics interface to generate compound map GUI objects. The metric information objects may include events that have occurred within the application environment 305. The relationship between the metric information objects may include set expressions and/or Boolean expressions. For example, the request may include graphically representing the intersection (or Boolean “AND” expression) of a first event and a second event.

The logic flow 500 may generate the compound map to graphically represent the relationship of the metrics information objects at block 508. For example, the map GUI component 218a may generate a map GUI object 176 in the form of a compound map GUI object 390 depicting a compound GUI object 385 for the metric information objects according to the relationship. For instance, for a request that includes the intersection (or Boolean “AND” expression) of a first event and a second event, the compound GUI object 385 may be generated at each location within the application environment 305 where the first event and the second event have occurred together or otherwise coincide.

The logic flow 500 may determine a user behavior based on the compound map at block 510. For example, the visual analytics application 150 may analyze the locations of and/or metrics information 152 associated with the compound GUI objects 385 presented on the compound map GUI object 390 to make one or more determinations of behavior information 226. For instance, the visual analytics application 150 may determine that the compound GUI objects 385 are associated with experienced users. In another instance, the visual analytics application 150 may determine that the compound GUI objects 385 only occur during a specified time period of game play.

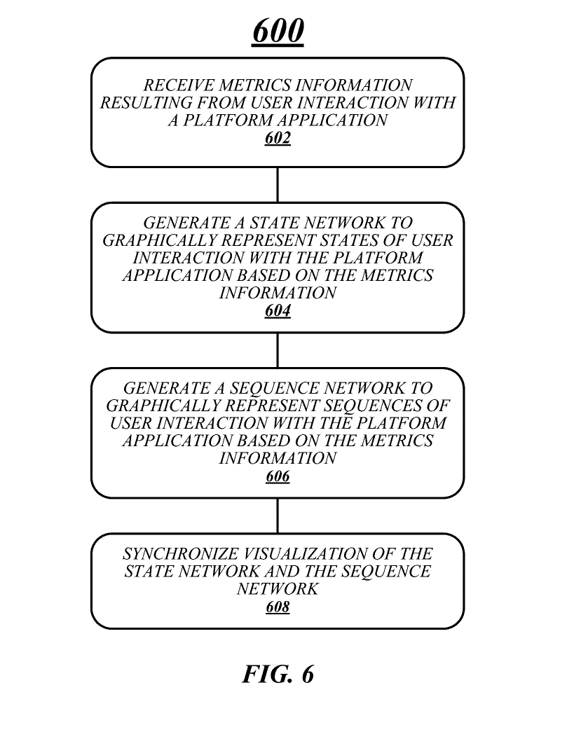

FIG. 6 depicts an illustrative logic flow according to a second embodiment. More specifically, FIG. 6 illustrates one embodiment of a logic flow 600. The logic flow 600 may be representative of some or all of the operations executed by one or more embodiments described herein. For example, the logic flow 600 may illustrate operations performed by the visual analytics system 100.

In the illustrated embodiment shown in FIG. 6, the logic flow 600 may receive metrics information at block 602. For example, the visual analytics application 150 may generate, receive, or otherwise access metrics information 152 associated with one or more platform applications 140. The metrics information 152 may be generated based on user interactions with a platform application 140. For example, the metrics information 152 may include records storing data relating to actions performed by platform users within the application environment of a platform application 140.

The logic flow 600 may generate a state network to graphically represent states of user interaction with the platform application based on the metrics information at block 604. For example, the network GUI component 218b may generate a network GUI object 178 in the form of a state network GUI object 405. The state network GUI object 405 may transform the metrics information 152 into nodes 410a-j and links 415 in one or more sequences. The logic flow 500 may generate a sequence network to graphically represent sequences of user interaction with the platform application based on the metrics information at block 606. For example, the network GUI component 218b may generate a network GUI object 178 in the form of a sequence network GUI object 430. The sequence network GUI object 430 may transform the metrics information 152 into nodes 420a-v configured to graphically represent sequences of user interaction with the platform application 140.

The logic flow 600 may synchronize visualization of the state network and the sequence network at block 608. For example, the network GUI component 218b may operate to provide a synchronized visualization of a state network GUI object 405 and a corresponding sequence network GUI object 430 within a single visual analytics interface 224. For instance, the network GUI component 218b may present the state network GUI object 405 immediately adjacent to the corresponding sequence network GUI object 430 for synchronized visualization of states, sequences, and/or the like, In some embodiments, the synchronized visualization function of the network GUI component 218b may operate to provide synchronized highlighting of GUI objects in a state network GUI object 405 and a corresponding sequence network GUI object 430.

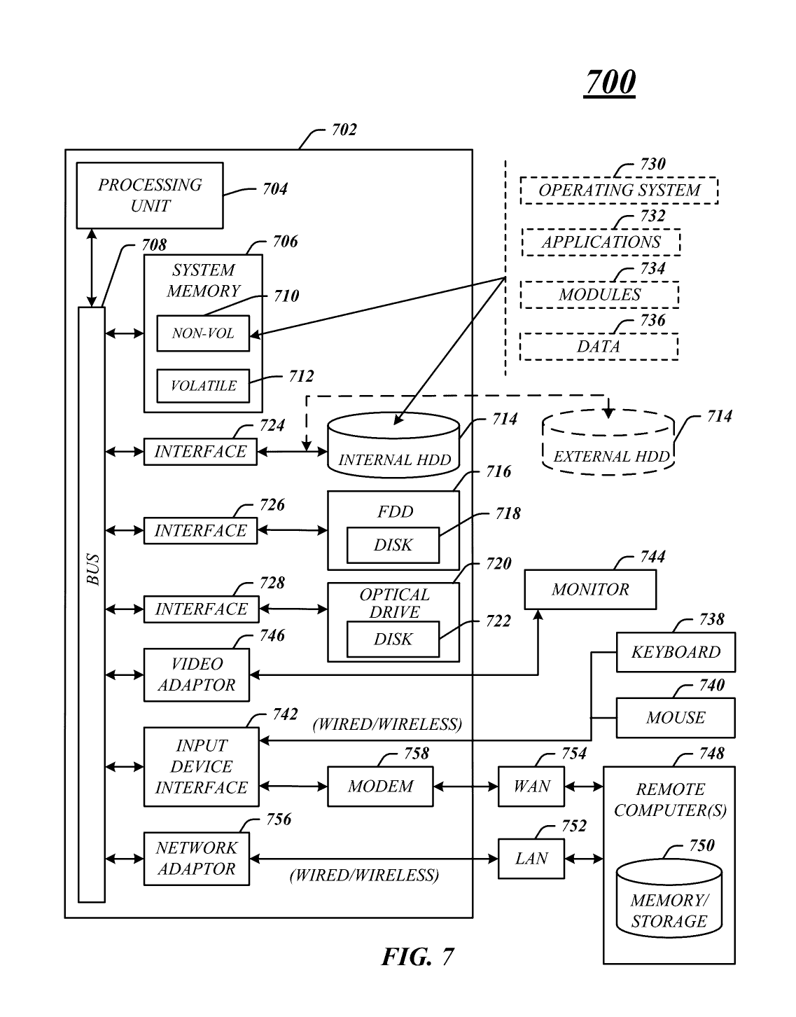

FIG. 7 illustrates an embodiment of a computing architecture 700 suitable for implementing various embodiments as previously described. More specifically, various aspects and/or portions of computing architecture 700 (or variants thereof) may be implemented as part of one or more systems, devices, embodiments and so forth to implement various particular features discussed above with respect to FIGS. 1-6. In one embodiment, one or more devices of computing architecture 700 may implemented as part of visual analytics system 100. Further, various components of computer architecture 700 may be used to implemented or enable any one of the processing flows previously discussed. Embodiments are not limited in this context.

Components may be communicatively coupled to each other by various types of communications media to coordinate operations. The coordination may involve the uni-directional or bi-directional exchange of information. For instance, the components may communicate information in the form of transmissions communicated over the communications media. The information can be implemented as transmissions allocated to various transmission lines. In such allocations, each message is a transmission. Further embodiments, however, may alternatively employ data messages. Such data messages may be sent across various connections. Exemplary connections include parallel interfaces, serial interfaces and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Processing unit 704 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing unit 704 may be connected to and communicate with the other elements of the computing system via an interconnect. Further, processing unit 704 may include other components, such as an uncore component including logic to process information, instructions and so forth not essential to core processing.

The system bus 708 provides an interface for system components including, but not limited to, the system memory 706 to the processing unit 704. The system bus 708 can be any of several types of bus structure that may further interconnect to a memory bus (with or without a memory controller), a peripheral bus and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA) and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory and so forth. Examples of logic may include executable computer program instructions implemented using any suitable type of code, such as source code, compiled code, interpreted code, executable code, static code, dynamic code, object-oriented code, visual code and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718 and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 628, respectively. The HDD interface 724 for external drive implementations can include at least one or both of Universal Serial Bus (USB) and IEEE 794 interface technologies.

The drives and associated computer-readable media provide volatile and/or nonvolatile storage of data, data structures, computer-executable instructions and so forth. For example, a number of program modules can be stored in the drives, non-volatile memory 710 and volatile memory 712, including an operating system 730, one or more application programs 732, other program modules 734 and program data 736. In one embodiment, the one or more application programs 732, other program modules 734 and program data 736 can include, for example, the various applications and/or components of system 100.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses and the like. These and other input devices are often connected to the processing unit 704 through an input device interface 742 that is coupled to the system bus 708, but can be connected by other interfaces such as a parallel port, IEEE 794 serial port, a game port, a USB port, an IR interface and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax and Bluetooth™ wireless technologies, 3G, 4G, LTE wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a processor circuit; and
a memory unit coupled to the processor circuit, the memory unit to store a visual analytics application operative on the processor circuit to graphically present metrics information of a platform application, the visual analytics application comprising:
a metrics component to receive metrics information, the metrics information to include indications of platform user interactions with the platform application, and
a GUI interface component to:
generate a visual analytics interface for presentation of at least one map graphical user interface (GUI) object to graphically represent at least a portion of the metrics information within an application environment,
receive a visualization request via at least one interactive selection GUI object, and
present the at least one map GUI object updated based on the visualization request.

2. The apparatus of claim 1, the platform application comprising a game application.

3. The apparatus of claim 1, the map GUI object comprising at least one of a heat map GUI object graphically depicting platform user movement within the application environment and an event icon GUI object graphically depicting at least one event within the application environment.

4. The apparatus of claim 1, the at least one interactive selection GUI object comprising at least one of an event selection GUI object and a platform user selection GUI object.

5. The apparatus of claim 1, the at least one interactive selection GUI object comprising at least one of a time selection GUI object and a compound map selection GUI object.

6. The apparatus of claim 5, the visualization request comprising a time period of interest determined via the time selection GUI object.

7. The apparatus of claim 6, the GUI interface component to present the at least one map GUI object updated based on the visualization request by graphically representing the at least a portion of the metrics information within the time period of interest.

8. The apparatus of claim 5, the visualization request comprising a compound event request determined via the compound map selection GUI object.

9. The apparatus of claim 8, the compound event request comprising at least two events and a relationship between the at least two events.

10. The apparatus of claim 9, the GUI interface component to present the at least one map GUI object updated based on the visualization request by graphically representing the at least two events according to the relationship.

11. The apparatus of claim 9, the relationship comprising a Boolean expression.

12. An apparatus, comprising:
a processor circuit; and
a memory unit coupled to the processor circuit, the memory unit to store a visual analytics application operative on the processor circuit to graphically present metrics information of a platform application, the virtual platform metrics application comprising:
a metrics component to receive metrics information generated by interaction with the platform application, and
a GUI interface component to:
generate a visual analytics interface for a synchronized presentation of a state map graphical user interface (GUI) object adjacent to a sequence map GUI object, the state map GUI object to graphically represent platform application states as nodes based on the metrics information, the sequence map GUI object to graphically represent platform application sequences as nodes based on the metrics information,
receive a visualization request via the visual analytics interface, and present the state map GUI object and the sequence map GUI object updated based on the visualization request.

13. The apparatus of claim 12, the visualization request comprising a selection of a sequence of nodes in the state map GUI object.

14. The apparatus of claim 13, the GUI interface component to update the sequence map GUI object by highlighting a node corresponding to the selection of the sequence of nodes in the state map GUI object.

15. The apparatus of claim 12, the visualization request comprising a selection of a node in the sequence map GUI object.

16. The apparatus of claim 15, the GUI interface component to update the state map GUI object by highlighting a sequence of nodes corresponding to the selection of the node in the sequence map GUI object.

17. A computer-implemented method to graphically present metrics information of a platform application, the method comprising, by a processor circuit:
receiving metrics information generated by interaction with the platform application;
generating a visual analytics interface for presentation of at least one map graphical user interface (GUI) object to graphically represent at least a portion of the metrics information within an application environment;
receiving a visualization request via at least one of a time selection GUI object and a compound map selection GUI object; and
presenting the at least one map GUI object updated based on the results of the visualization request.

18. The method of claim 17, comprising presenting the at least one map GUI object updated based on the visualization request by graphically representing the at least a portion of the metrics information within a time period of interest determined via a time selection GUI object.

19. The method of claim 17, the visualization request comprising a compound event request determined via a compound map selection GUI object, the compound event request comprising at least two events and a relationship between the at least two events.

20. The method of claim 19, comprising presenting the at least one map GUI object updated based on the visualization request by graphically representing the at least two events according to the relationship.
